(19) United States
(12) Patent Application Publication
(10) Pub. No.: US 2025/0285309 A1
(43) Pub. Date: Sep. 11, 2025

(54) METHODS, STORAGE MEDIA, AND SYSTEMS FOR MEASURING AN ANGLE OF A ROOF FACET

(71) Applicant: Hover Inc., San Francisco, CA (US)

(72) Inventors: Jeffrey Sommers, Mountain View, CA (US); Harsh Barbhaiya, San Francisco, CA (US); Patrick Russell Stuart, Austin, TX (US)

(21) Appl. No.: 18/859,062

(22) PCT Filed: Apr. 26, 2023
(86) PCT No.: PCT/US2023/020038

§ 371 Date: Oct. 22, 2024

Related U.S. Application Data
(60) Provisional application No. 63/336,895, filed on Apr. 29, 2022.
(60) Provisional application No. 63/417,148, filed on Oct. 18, 2022.

(51) Int. Cl. G06T 7/60; G05D 1/646; G05D 101/15; G05D 105/80; G05D 109/20; G05D 111/10; G06T 7/80; G06T 7/90; G06V 10/56; G06V 10/70; G06V 20/10; G06V 20/17

(52) U.S. Cl. CPC G06T 7/60; G05D 1/646; G06T 7/80; G06T 7/90; G06V 10/56; G06V 10/70; G06V 20/17; G06V 20/176; G05D 2101/15; G05D 2105/89; G05D 2109/20; G05D 2111/10; G06T 2207/10032; G06T 2207/30184; G06T 2207/30252

(57) ABSTRACT

Methods, storage media, and systems for measuring an angle of a roof facet are disclosed. Exemplary implementations may include initiating a flight path for an image capture device, the flight path including, at successively greater heights, a starting position, a calibration position, and an orthographic position above the roof facet. A first fiducial is detected as or at the calibration position and a second fiducial is detected concurrent with movement of the image capture device along the flight path towards the orthographic position. An elevation change of the image capture device is measured between the first fiducial and second fiducial. An orthographic image of the roof facet is captured from the orthographic position. An outline of the roof facet is generated from the orthographic image. A pitch of the roof is calculated from the outline of the roof facet and the elevation change.

### CROSS-REFERENCE TO RELATED APPLICATIONS

This application claims priority to U.S. Prov. Patent App. No. 63/336,895 titled “METHODS, STORAGE MEDIA, AND SYSTEMS FOR MEASURING AN ANGLE OF A ROOF FACET” and filed on Apr. 29, 2022. This application further claims priority to U.S. Prov. Patent App. No. 63/417,148 titled “METHODS, STORAGE MEDIA, AND SYSTEMS FOR MEASURING AN ANGLE OF A ROOF FACET” and filed on Oct. 18, 2022. Each of the above-recited applications are hereby incorporated herein by reference in their entirety.

### TECHNICAL FIELD

The present disclosure relates to methods, storage media, and systems for measuring an angle of a roof facet.

### BACKGROUND

Determining the pitch of roof facets using image processing using known techniques requires several images, which may be difficult or cumbersome to obtain. Solutions for simplifying the determination of an angle of a roof facet (the pitch) are desired.

### SUMMARY

Two-dimensional images, especially those represented by visual channels only (e.g. RGB images), may convey helpful visual data or cues but are otherwise ill-suited for conveying reliable information for geometries that do not conform to the flat two dimensions of the image plane. When objects in the real world, such as objects with surfaces that have changes to a z value on a z-axis extending orthogonal to the image plane defined by x and y-axes, are captured in a two-dimensional image, it may be difficult to discern information for the surface, since the z-axis, as a third dimension to the image plane, may not be apparent in the two dimensions of the image. A front-parallel perspective of an object, wherein a flat surface of the object is orthogonal to the optical axis of a camera that captured the object in an image, conveys consistent interpretation for the width and height of that surface in the image because those dimensions of the surface are parallel to the axes of the image. As a result, the pixels corresponding to those dimensions of the surface of the object may be understood to be proportional to the dimensions of that surface of the object. When an object's surface is angled relative to the camera's optical axis, the lack of a third dimension for the two-dimensional image introduces complexity in measuring the angled surface. Previous attempts to address this problem involve associating known relationships in one image to similar relationships in another image. Such a technique is disclosed in U.S. Patent Pub. 2011/0064312. These techniques, however, require multiple images and the correlation of points among images is subject to occlusion, false positive matches, or false negative matches, in addition to requiring additional images and computing or human resources. Various implementations disclosed herein advantageously introduce a non-visual parameter into an image processing pipeline to derive depth perspective (e.g., z-axis information) for angled objects in a two-dimensional image.

In some implementations, the angled object is a roof facet to a building structure. In some implementations, the non-visual parameter is a translation distance of an imager (e.g., a camera). In some implementations, the translation distance is an elevation change between separate fiducials. In some implementations, the elevation change is the elevation change of a drone having an imager, with the elevation change occurring as the drone moves along its flight path. In some implementations, the elevation change corresponds to values on a z-axis, which may be substantially orthogonal to an image plane for images of the building.

One aspect of the present disclosure relates to a method for measuring an angle of a roof facet. The method may include initiating a flight path for an image capture device. The flight path may include a launch phase and a measurement phase. The launch phase may initiate from a starting position and ends at a calibration position and the measurement phase initiates from the calibration positions and ends at an orthographic position above an object including the roof facet. The method may include detecting a first fiducial concurrent with the flight path towards the calibration position. The method may include detecting a second fiducial concurrent with the flight path towards the orthographic position. The method may include measuring an elevation change of the image capture device between the first fiducial and second fiducial. The method may include capturing an orthographic image of the roof facet from the orthographic position. The method may include generating an outline of the roof facet from the orthographic image. The method may include calculating a pitch of the roof from the outline of the roof facet and the elevation change.

Another aspect of the present disclosure relates to a non-transient computer-readable storage medium having instructions embodied thereon, the instructions being executable by one or more processors to perform a method for measuring an angle of a roof facet. The method may include initiating a flight path for an image capture device. The flight path may include a launch phase and a measurement phase. The launch phase may commence from a starting position and ends at a calibration position and the measurement phase commences from the calibration position and ends at an orthographic position above an object including the roof facet. The method may include detecting a first fiducial concurrent with the flight path towards the calibration position. The method may include detecting a second fiducial concurrent with the flight path towards the orthographic position. The method may include measuring an elevation change of the image capture device between the first fiducial and second fiducial. The method may include capturing an orthographic image of the roof facet from the orthographic position. The method may include generating an outline of the roof facet from the orthographic image. The method may include calculating a pitch of the roof from the outline of the roof facet and the elevation change.

Yet another aspect of the present disclosure relates to a system configured for measuring an angle of a roof facet. The system may include one or more hardware processors configured by machine-readable instructions. The processor(s) may be configured to initiate a flight path for an image capture device. The flight path may include a launch phase and a measurement phase. The launch phase may commence from a starting position and end at a calibration position and the measurement phase commences from the calibration positions and ends at an orthographic position above an object including the roof facet. The processor(s) may be configured to detect a first fiducial concurrent with the flight path towards the calibration position. The processor(s) may be configured to detect a second fiducial concurrent with the flight path towards the orthographic position. The processor(s) may be configured to measure an elevation change of the image capture device between the first fiducial and second fiducial. The processor(s) may be configured to capture an orthographic image of the roof facet from the orthographic position. The processor(s) may be configured to generate an outline of the roof facet from the orthographic image. The processor(s) may be configured to calculate a pitch of the roof from the outline of the roof facet and the elevation change.

One aspect of the present disclosure relates to a method for measuring an angle of a roof facet. The method may include initiating a flight path for an image capture device. The flight path may include a calibration position and an orthographic position above an object including the roof facet. The method may include detecting a first fiducial concurrent with the flight path towards the calibration position. The method may include detecting a second fiducial concurrent with the flight path towards the orthographic position. The method may include measuring an elevation change of the image capture device between the first fiducial and second fiducial. The method may include capturing an orthographic image of the roof facet from the orthographic position. The method may include generating an outline of the roof facet from the orthographic image. The method may include calculating a pitch of the roof from the outline of the roof facet and the elevation change.

Another aspect of the present disclosure relates to a non-transient computer-readable storage medium having instructions embodied thereon, the instructions being executable by one or more processors to perform a method for measuring an angle of a roof facet. The method may include initiating a flight path for an image capture device. The flight path may include a calibration position and an orthographic position above an object including the roof facet. The method may include detecting a first fiducial concurrent with the flight path towards the calibration position. The method may include detecting a second fiducial concurrent with the flight path towards the orthographic position. The method may include measuring an elevation change of the image capture device between the first fiducial and second fiducial. The method may include capturing an orthographic image of the roof facet from the orthographic position. The method may include generating an outline of the roof facet from the orthographic image. The method may include calculating a pitch of the roof from the outline of the roof facet and the elevation change.

Yet another aspect of the present disclosure relates to a system configured for measuring an angle of a roof facet. The system may include one or more hardware processors configured by machine-readable instructions. The processor(s) may be configured to initiate a flight path for an image capture device. The flight path may include a calibration position and an orthographic position above an object including the roof facet. The processor(s) may be configured to detect a first fiducial concurrent with the flight path towards the calibration position. The processor(s) may be configured to detect a second fiducial concurrent with the flight path towards the orthographic position. The processor(s) may be configured to measure an elevation change of the image capture device between the first fiducial and second fiducial. The processor(s) may be configured to capture an orthographic image of the roof facet from the orthographic position. The processor(s) may be configured to generate an outline of the roof facet from the orthographic image. The processor(s) may be configured to calculate a pitch of the roof from the outline of the roof facet and the elevation change.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for measuring an angle of a roof facet, according to some implementations.

FIG. 2 illustrates a method for measuring an angle of a roof facet, according to some implementations.

FIG. 3A illustrates a drone navigating proximate to a building, according to some implementations.

FIG. 3B illustrates the drone of FIG. 3A navigating to a first height of a first fiducial of the building, according to some implementations.

FIG. 3C illustrates the drone of FIG. 3B navigating to a second height of a second fiducial of the building, according to some implementations.

FIG. 3D illustrates the drone ascending to an orthographic position and obtaining an image of the building, according to some implementations.

FIG. 4 illustrates identification of a plurality of fiducials, according to some implementations.

FIG. 5 illustrates associating calibration settings based on heights of a plurality of fiducials, according to some implementations.

FIGS. 6A-6C illustrate deriving multiple distance calibrations within a single image.

FIG. 7 illustrates multichannel bounding boxes, according to some implementations.

FIG. 8 illustrates a channel output for a substructure, according to some implementations.

FIG. 9 illustrates a plurality of channels associated with activation maps, according to some implementations.

FIGS. 10A-11B illustrate scene understanding for images, according to some implementations.

FIGS. 12A-12B illustrate operations for generating channel output for substructure identification, according to some implementations.

FIGS. 13-14B illustrate grouping operations for identifying substructures, according to some implementations.

Implementations of the present disclosure and their advantages may be understood by referring to the detailed description that follows. It should be appreciated that like reference numerals are used to identify like elements illustrated in one or more of the figures, wherein showings therein are for purposes of illustrating implementations of the present disclosure and not for purposes of limiting the same.

### DETAILED DESCRIPTION

The present disclosure describes techniques to determine a pitch associated with one or more roof facets on a building, such as a home or other dwelling. Roof pitch, as an example, describes the incline of a roof facet (e.g., a section of a multi-sectional roof) and may represent a ratio of the rise to the run. The techniques described herein may use an unmanned aerial vehicle (hereinafter referred to as a drone) which is equipped with at least one camera. The camera may be adjusted (e.g., positioned in one or more orientations), such that it is able to capture images in a downwards direction (e.g., substantially orthogonal to the ground or surface) or forward directions (e.g., substantially parallel to the ground or surface).

As will be described, an image (e.g., a single image) from the drone may be used, in part, to determine the pitch of a roof. In contrast, prior techniques relied upon different images of a building taken using different perspectives. For these prior techniques, information from the images may be combined. For example, a three-dimensional model or three-dimensional information associated with the building may be determined using the combination. In this example, pitch may be subsequently extracted. Thus, multiple images may be required which may increase a complexity associated with determining pitch.

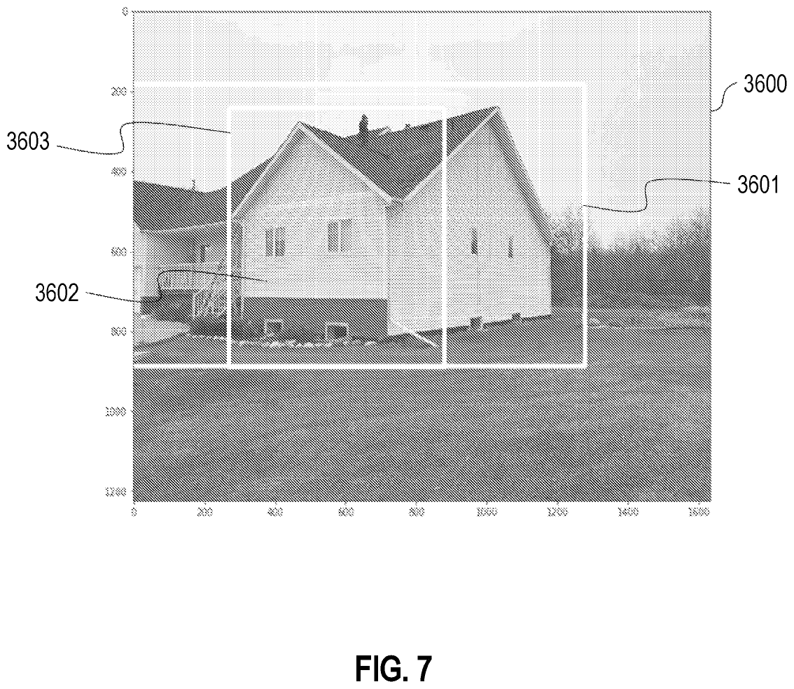

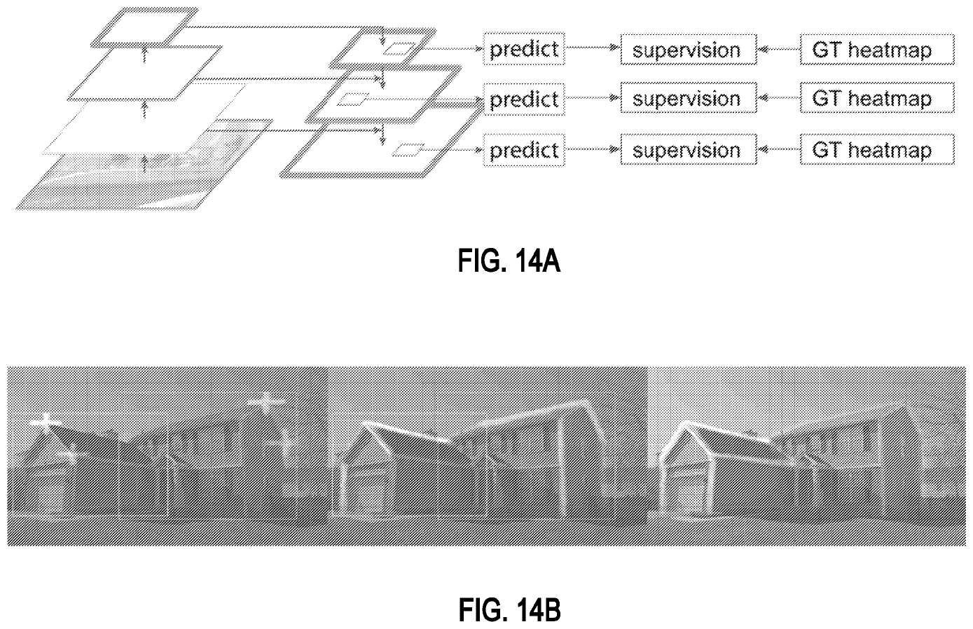

To determine pitch of a roof facet, the drone may ascend proximate to a building up to a first fiducial, e.g., such that the drone is at the same height, relative to the elevation of the starting point of the drone, as the first fiducial. In some implementations, a fiducial is a semantic label observed in an image observed (e.g., captured) by the drone. In some implementations, semantic labels may be generated as disclosed in U.S. Patent Pub. 2021/0243362, the entirety of which is incorporated by reference herein, and as discussed below with reference to FIGS. 7-14B.

In some implementations, the first fiducial may be gutters of the building. Preferably, the first fiducial is at the same height as part of the roof facet. As may be appreciated, the gutters may form part of the end of the roof facet. Subsequently, the drone may ascend to a second fiducial, e.g., such that the drone is at the same height, relative to the elevation of the starting point of the drone, as the second fiducial. Preferably, the second fiducial is at the same height as part of the roof facet and is also at a height greater than the first fiducial. In some implementations, the second fiducial may be a roof apex or ridge line of the roof facet. The distance (e.g., vertical or elevation distance) between the first fiducial and second fiducial may indicate the rise of the pitch. In some implementations, the height of the drone may be determined using an emitting sensor (e.g., an ultrasonic sensor that emits and receives ultrasonic sound base, a light-based sensor that emits and receives light), using its cameras, GPS (e.g., differential GPS), and so on. In some implementations where the first and/or second fiducial extends linearly and horizontally, vertical alignment with a particular fiducial may be considered to be achieved when the camera of the drone is on the same horizontal plane as the fiducial (e.g., when the optical axis of the camera of the drone is effectively coextensive with the line defined by the fiducial).

After the determination of the rise, the drone may ascend to a greater height (referred to herein as an orthographic position). In some implementations, the greater height may be a fixed height such as 150 feet, 200 feet, 250 feet, and so on above a dwelling. In some implementations, the greater height may represent a height at which the drone's camera captures all, or substantially all, of the roof of the dwelling. While at the greater height, the drone may obtain an image with the camera pointing downward (e.g., orthogonal to the ground). It will be appreciated that the drone may ascend to the various above-noted positions (e.g., a height of the first fiducial, a height of the second fiducial, and a height of the orthographic position) in steps, such that the drone pauses at some or all of these positions, or may move continuously. For example, the drone may move continuously up to the height of the orthographic position, e.g., at a constant speed and/or while reducing speed at some or all of these positions.

To determine the run of the pitch, the image may be analyzed (e.g., by processors included in the drone, by a user device which receives the image, by a system which receives inputs (such as the image) from the drone, and so on). For example, an outline of the roof facet may be determined. In some implementations, calibration information may be used which reflects, for example, real-world data represented by pixels in the image. For example, the calibration information may allow for a determination of the real-world measurements of lines (e.g., orthogonal lines) which are depicted in images taken at the greater height. Thus, and as an example, if the height or elevation of the drone is 200 feet, then pixels in the corresponding image can be scaled to that calibration. For example, it may be appreciated that there exists a plane (e.g., 200 feet away from the camera, and orthogonal to the camera's optical axis) where the calibration information may be used to inform the geometric distance between pixels on the plane. In some implementations, the camera is elevated to a height (e.g., by upward movement of the drone to which the camera is attached) of such a plane. The height of the camera and the lateral distance of the camera to the building are preferably selected to provide an orthographic top-down view of the building at the plane, and that camera location may be referred to as the orthographic position. For example, in some implementations, at the plane, the drone may be directly or essentially directly overhead the building, or may be at a location following a vertical line (e.g., a flight path of the drone) extending immediately adjacent a perimeter of the building. In some implementations, where the first and second fiducials are part of the roof facet, the run may be the real-world horizontal (e.g., in a direction parallel to or co-planar with, a calibration plane) distance between these fiducials.

Thus, the image may be used to determine run and may be combined with the rise to determine pitch of the roof. For example, the pitch of the roof may be the pitch determined for the roof facet in a gable-type roof which includes two roof facets that meet at a ridge line. While the disclosure herein describes determining an individual pitch, as may be appreciated pitches for more than two roof facets on a dwelling may be determined and fall within the scope of the disclosure.

In some implementations, the drone described herein may receive a flight plan, or other information, which indicates different positions to which the drone is to ascend. For example, the flight plan may indicate that the drone is to position its camera to point forwards. The flight plan may indicate that the drone is to identify respective heights at which the first fiducial and second fiducial are disposed. The flight plan may additionally indicate that the drone is to ascend to the orthographic position as described herein and obtain an image. Thus, in some implementations actions of the drone may be substantially automated.

In some implementations, the drone may provide or relay images or video to a user device. For these implementations, the drone may ascend to a height of the first fiducial and wait until a user of the user device confirms that the drone has identified, for example, a gutter. The drone may then ascend to a different height of the second fiducial and wait until the user confirms that the drone has identified, for example, the ridge line or apex. In some implementations, the drone may receive commands or actions from a user device in substantially real-time. In some implementations, identification of the fiducials may be accomplished without user input. For example, the drone or connected systems may automatically identify the fiducials by analysis of images or video captured by at least one sensor of the imager.

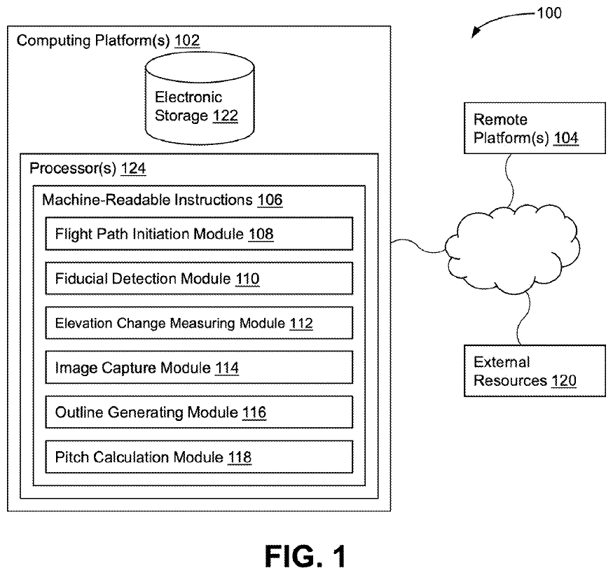

FIG. 1 illustrates a system 100 configured for measuring an angle of a roof facet, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of flight path initiation module 108, fiducial detection module 110, elevation change measuring module 112, image capture module 114, outline generating module 116, pitch calculation module 118, and/or other instruction modules.

Flight path initiation module 108 may be configured to initiate a flight path for an image capture device. The image capture device may be coupled to a drone. The flight path may include a launch phase and a measurement phase. The launch phase may commence from a starting position and end at a calibration position, and the measurement phase may commence from the calibration position and end at an orthographic position above an object including the roof facet. The orthographic position may be at a fixed height above the calibration position.

The fixed height may be 200 feet in some implementations. An optical axis of the image capture device may be substantially parallel to the ground concurrent with the flight path and prior to the calibration position. The optical axis of the image capture device may be substantially orthogonal to the ground concurrent with the flight path prior to the orthographic position. The image capture device may be calibrated for converting pixel dimensions of features associated with the calibration position into geometric measurements from the orthographic position.

Fiducial detection module 110 may be configured to detect a first fiducial concurrent with the flight path towards the calibration position. The first fiducial may be detected by an object recognition machine learning network. The first fiducial detected by the object recognition machine learning network may be a gutter coupled to the roof facet. The first fiducial detected by the object recognition machine learning network may be an eave to the roof facet. The first fiducial detected by the object recognition machine learning network may be a fascia line to the roof facet.

The first fiducial may be detected by line detection of a horizontal line. The first fiducial may be detected by user input confirming the presence of the first fiducial at the elevation of the image capture device detection of a horizontal line. Detecting the first fiducial may establish the calibration position of the flight path.

Fiducial detection module 110 may be configured to detect a second fiducial concurrent with the flight path towards the orthographic position. The optical axis of the image capture device may be substantially parallel to the ground concurrent with the flight path prior to detecting the second fiducial.

Elevation change measuring module 112 may be configured to measure an elevation change of the image capture device between the first fiducial and second fiducial. The second fiducial may be detected by an object recognition machine learning network. The second fiducial detected by the object recognition machine learning network may be a roof apex. The second fiducial detected by the object recognition machine learning network may be a ridge line. The second fiducial may be a change of color intensity, or a change of depth gradient sensed by a time-of-flight sensor.

Image capture module 114 may be configured to capture an orthographic image of the roof facet from the orthographic position.

Outline generating module 116 may be configured to generate an outline of the roof facet from the orthographic image.

Pitch calculation module 118 may be configured to calculate a pitch of the roof from the outline of the roof facet and the elevation change.

In some implementations, computing platform(s) 102, remote platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 120 may be operatively linked via some other communication media.

A given remote platform 104 may include one or more processors configured to execute computer program modules. The computer program modules may be configured to enable an expert or user associated with the given remote platform 104 to interface with system 100 and/or external resources 120, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms. External resources 120 may include sources of information outside of system 100, external entities participating with system 100, and/or other resources. In some implementations, some or all of the functionality attributed herein to external resources 120 may be provided by resources included in system 100. Computing platform(s) 102 may include electronic storage 122, one or more processors 124, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 122 may comprise non-transitory storage media that electronically stores information. The electronic storage media of electronic storage 122 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from computing platform(s) 102, information received from remote platform(s) 104, and/or other information that enables computing platform(s) 102 to function as described herein.

Processor(s) 124 may be configured to provide information processing capabilities in computing platform(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute modules 108, 110, 112, 114, 116, and/or 118, and/or other modules. Processor(s) 124 may be configured to execute modules 108, 110, 112, 114, 116, and/or 118, and/or other modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, and/or 118 are illustrated in FIG. 1 as being implemented within a single processing unit, in implementations in which processor(s) 124 includes multiple processing units, one or more of modules 108, 110, 112, 114, 116, and/or 118 may be implemented remotely from the other modules. The description of the functionality provided by the different modules 108, 110, 112, 114, 116, and/or 118 described below is for illustrative purposes, and is not intended to be limiting, as any of modules 108, 110, 112, 114, 116, and/or 118 may provide more or less functionality than is described. For example, one or more of modules 108, 110, 112, 114, 116, and/or 118 may be eliminated, and some or all of its functionality may be provided by other ones of modules 108, 110, 112, 114, 116, and/or 118. As another example, processor(s) 124 may be configured to execute one or more additional modules that may perform some or all of the functionality attributed below to one of modules 108, 110, 112, 114, 116, and/or 118.

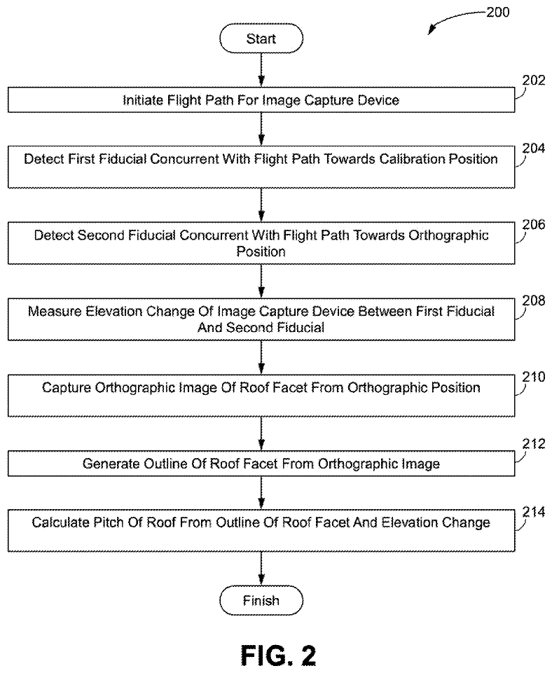

FIG. 2 illustrates a method 200 for measuring an angle of a roof facet, in accordance with one or more implementations. The operations of method 200 presented below are intended to be illustrative. In some implementations, method 200 may be accomplished with one or more additional operations not described, and/or may omit one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include initiating a flight path for an image capture device. The flight path may include a launch phase and a measurement phase. The launch phase may commence from a starting position and end at a calibration position and the measurement phase commences from the calibration positions and ends at an orthographic position above an object including the roof facet. Operation 202 may be performed by one or more hardware processors configured by machine-readable instructions including a module that is the same as or similar to flight path initiation module 108, in accordance with one or more implementations.

An operation 204 may include detecting a first fiducial concurrent with the flight path towards the calibration position. Operation 204 may be performed by one or more hardware processors configured by machine-readable instructions including a module that is the same as or similar to fiducial detection module 110, in accordance with one or more implementations.

An operation 206 may include detecting a second fiducial concurrent with the flight path towards the orthographic position. Operation 206 may be performed by one or more hardware processors configured by machine-readable instructions including a module that is the same as or similar to fiducial detection module 110, in accordance with one or more implementations.

An operation 208 may include measuring an elevation change of the image capture device between the first fiducial and second fiducial. Operation 208 may be performed by one or more hardware processors configured by machine-readable instructions including a module that is the same as or similar to elevation change measuring module 112, in accordance with one or more implementations.

An operation 210 may include capturing an orthographic image of the roof facet from the orthographic position. Operation 210 may be performed by one or more hardware processors configured by machine-readable instructions including a module that is the same as or similar to image capture module 114, in accordance with one or more implementations.

An operation 212 may include generating an outline of the roof facet from the orthographic image. Operation 212 may be performed by one or more hardware processors configured by machine-readable instructions including a module that is the same as or similar to outline generating module 116, in accordance with one or more implementations.

An operation 214 may include calculating a pitch of the roof from the outline of the roof facet and the elevation change. Operation 214 may be performed by one or more hardware processors configured by machine-readable instructions including a module that is the same as or similar to pitch calculation module 118, in accordance with one or more implementations.

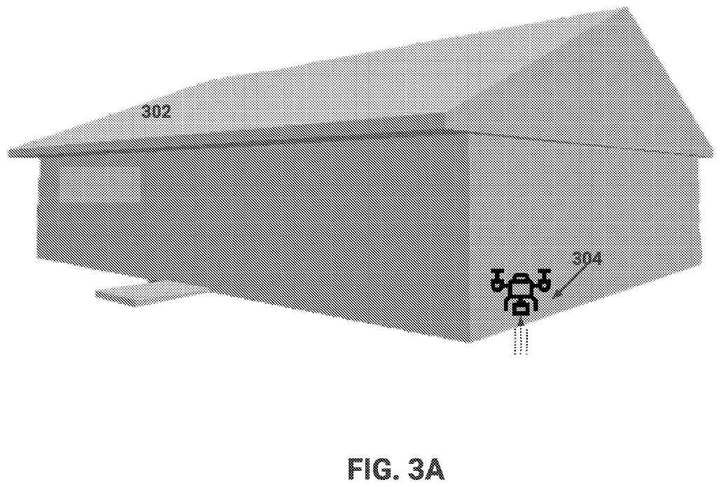

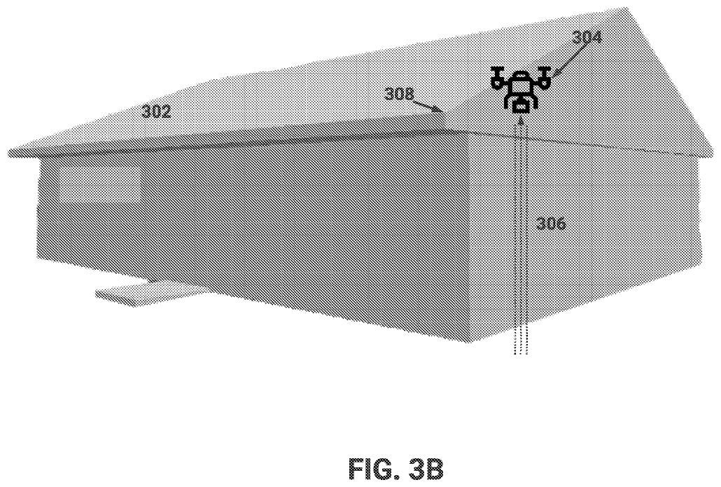

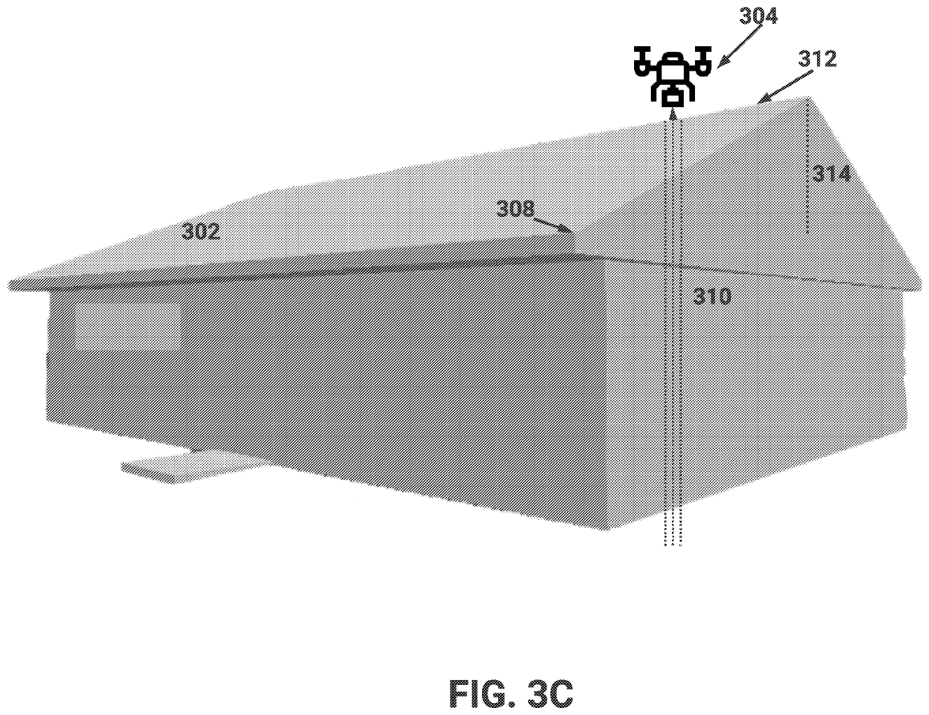

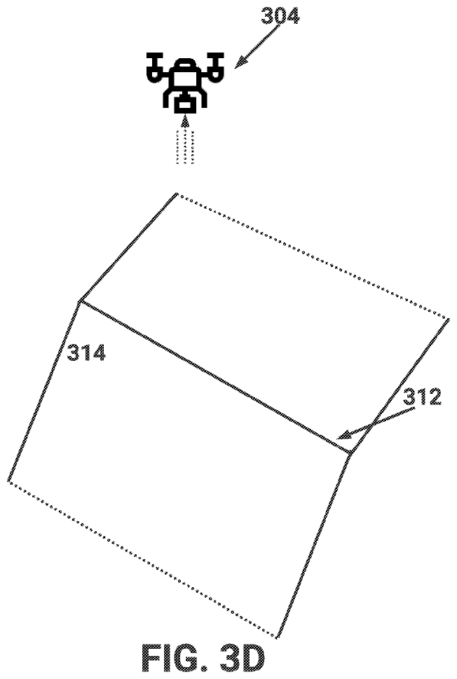

FIG. 3A illustrates a drone 304 navigating proximate to a building. As described above, the drone 304 may be proximate to a building and ascend from the ground or other initial position. For example, the drone 304 may ascend near a corner or side of the building where a first fiducial is positioned. In some implementations, the drone may execute or implement a flight plan or other information or instructions which is associated with determining pitch.

FIG. 3B illustrates the drone 304 navigating to a first height 306 of a first fiducial 308 on the building. The first fiducial may represent, for example, a gutter, drain, an eave to the roof facet 302, fascia line to the roof facet 302, or other feature of the roof facet, as described herein. At the height 306, the drone 304 may record or otherwise store information indicating height of the first fiducial.

In some implementations, the drone 304 may execute a machine learning model such as a convolutional neural network, transformer network, and so on, which processes images or video from a camera of the drone 304 (e.g., computes forward passes through the network). For example, the camera may point substantially forward (e.g., parallel to the ground) such that the images or video represent a forward view of the drone 304. The model may output, for example, a bounding box about the first fiducial. The model may also allow the drone 304 to determine a height associated with the first fiducial. For example, the drone 304 may effectuate adjustments to its height until the drone 304 (e.g., the camera) is at the height of the first fiducial (e.g., a specific portion thereof, such as the top, bottom, middle, of the first fiducial). The model may also facilitate using the drone 304 to determine the height of the first fiducial based on the drone's 304 present height and the camera's view of the fiducial. For example, the drone 304 may determine an offset of its height based on its view of the fiducial. In this example, if the drone's camera includes a view of the first fiducial the offset may indicate that the drone 304 is above or below the first fiducial.

In some implementations, the drone 304 may detect the first fiducial using computer vision techniques. For example, the drone 304 may detect a horizontal line on the building which may indicate the beginning of the roof facet 302.

FIG. 3C illustrates the drone 304 navigating to a second height 310 of a second fiducial 312 on the building. The drone 304 may ascend from the height 306 of the first fiducial 308 until reaching the second fiducial 312.

As described above, the second fiducial may be a roof apex, ridge line, and so on. In some implementations, the second fiducial may be detected using the machine learning model described above. For example, the model may be trained to identify different types of fiducials. In some implementations, the second fiducial may be detected based on a change of color intensity associated with the images. For example, the ridge line may be detectable based on its color values being distinct from those of the broad portion of the roof facet.

The second height 310 may thus be recorded or otherwise stored by the drone 304. The difference between the second height 310 and first height 306 may represent the rise 314 of the pitch associated with the roof. In some implementations, the drone 304 may calculate this rise 314 based on an extent to which it ascended until detecting the second fiducial 312. In some implementations, a user device or system may determine the rise based on information received from the drone 304 (e.g., the first height 306 and second height 310).

FIG. 3D illustrates the drone 304 ascending to an orthographic position and obtaining an image of the building. The image, as described herein, may be used to determine the run of the pitch associated with the roof. As described above, the orthographic position may be a particular height above the second height 310, such as 150 feet, 200 feet, and so on. This height may allow for an entirety of the roof facet, or roof, to be depicted in the image. In implementations in which multiple roof facets are detected, the image of the entire roof may allow for a determination of pitch for each of the facets.

As described above, an outline of the roof 314 may be identified based on the image. For example, the drone 304, a user device, or a system, may analyze the image. The orthographic position may be associated with calibration information such that a measure of a distance in the image may be translated into a real-world distance. Thus, the run (e.g., the width of the roof facet as observed in the image) may be determined based on the outline of the roof 314, for example by measuring in an orthogonal direction from a ridge line of a roof to an outline border (e.g., as seen in a top-down two-dimensional view). In some implementations, an outline may not be determined and a line which extends from the edge of the roof facet to the second fiducial 312 may be identified. The length of the line (e.g., number of pixels) may be translated into a real-world value and may be understood to represent the run. In some implementations, the image obtained at the orthographic position contains both the first and second fiducials, such that the run may be understood to be the horizontal distance between these fiducials.

It will be appreciated that a camera may have a calibration plane that includes a calibration data point, which may correspond to the location of a structural feature. For an image of the structural feature captured by the camera positioned at a preset calibrated distance away from the calibration point (e.g., at an orthographic position), pixel distances in the image may be understood to correspond to real-world distance values (e.g., length or width values).

In some implementations, multiple calibration planes are identified, or multiple calibration settings within a single image are generated to determine real-world values for different features of a structure that are at different elevations or heights. For example, a distinct calibration plane may be identified for each elevation having a feature for which real-world values are desired. In the description herein, reference may be made to the elevation or height of a drone. It will be appreciated that the drone includes an imager and that references to the drone elevation or height may be understood also refer to the elevation or height of the imager that is included with the drone.

Identification of a fiducial at a particular drone elevation establishes a calibration data point, and identification of subsequent fiducials establishes additional calibration data points, each of which may be used in providing a calibration setting particular to the corresponding calibration data point. In some implementations, identification of a first fiducial establishes a first calibration data point and a related first calibration setting, wherein the height of the drone at the orthographic position is calibrated to convert, in images captured from the orthographic position, pixel distances into geometric measurements between points observed on the calibration plane associated with the first calibration setting. In other words, an imager may be calibrated such that its images, captured from the orthographic position relative to a calibration plane, produce a known geometric relationship between certain pixels corresponding to real features that fall on a common plane orthogonal to the imager. In some implementations, as the drone progresses to an orthographic position and observes additional fiducials (e.g., a start of a new roof facet like a dormer, or an apex to a facet) new calibration settings may be established for additional calibration planes in a single image captured from the orthographic position. The resultant image may then have a plurality of calibrations for certain geometries within the image, as a function of the height of the drone when a particular fiducial was observed.

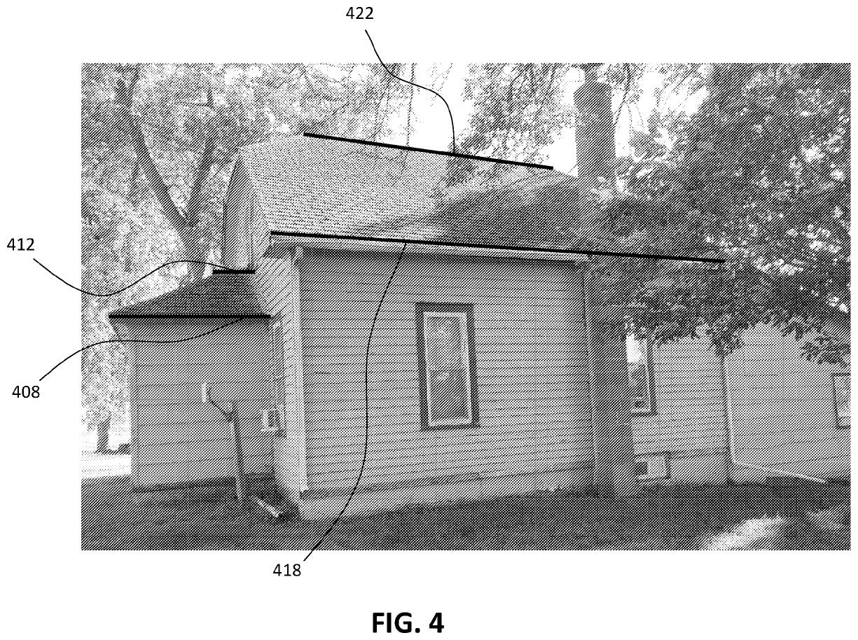

FIG. 4 illustrates a plurality of semantic labels identified as fiducials during movement of a drone along a flight path. Eave line 408 may be identified first; given its lower height relative to other features, it is more likely to be observed earlier, e.g., during a launch phase from the ground. Identification of eave line 408 may establish a first calibration setting or calibration position from which a drone proceeds through the measurement phase of its flight path to an orthographic position above the structure. During the measurement phase, the drone continues to identify additional fiducials such as ridge line 412, second eave line 418, and second ridge line 422; each fiducial identification establishes a corresponding calibration setting for that associated fiducial.

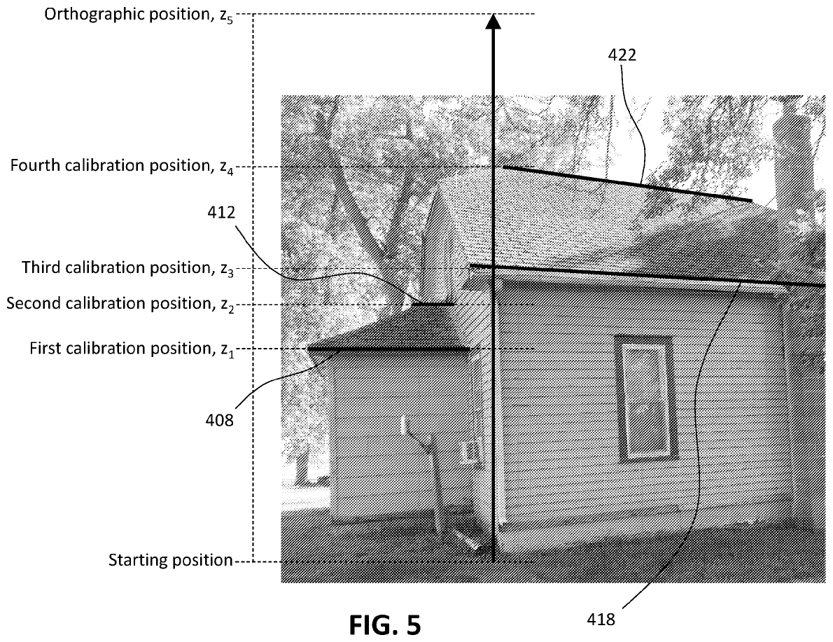

FIG. 5 illustrates determining a calibration factor, relative to a first calibration setting, for subsequent calibration settings associated with additional fiducials. A drone may initiate a flight path from a starting position, and progress via a launch phase to a first calibration setting at a height of z₁, associated with the fiducial 408. As the drone continues in a measurement phase to an orthographic position z₅ at a certain height above the structure relative to this first calibration position, additional calibration settings at heights z₂, z₃, and z₄ are associated with the observed fiducials 412, 418, 422.

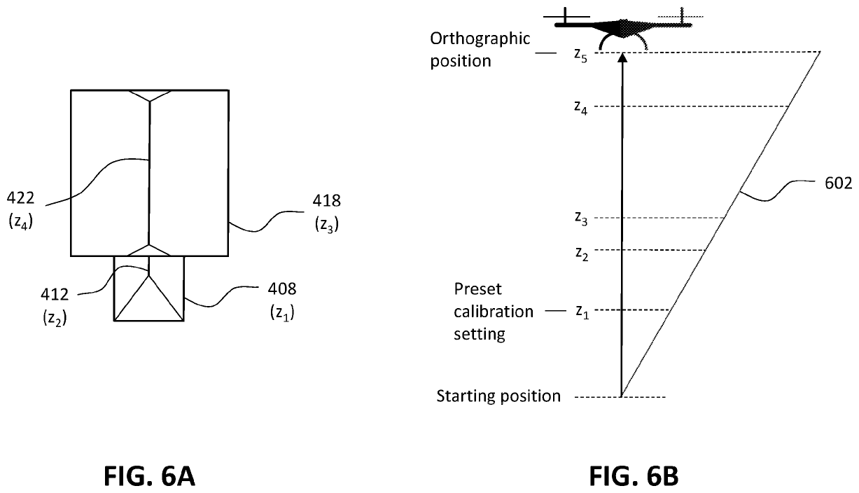

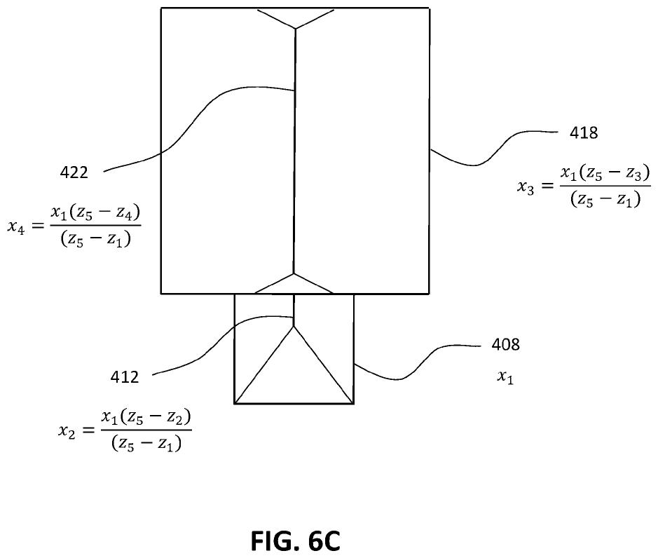

FIG. 6A illustrates a top-down view of the structure of FIGS. 4 and 5, with eave line 408 associated with calibration setting z₁, ridge 412 associated with second calibration setting z₂, second eave line 418 associated with third calibration setting z₃, and second ridge line 422 associated with fourth calibration setting z₄. In some implementations, a multi-calibrated image is created by applying a calibration adjustment factor relative to the height of an additional calibration setting and the camera intrinsics.

FIG. 6B illustrates a distance-per-pixel calibration adjustment factor 602. As the height of the imager increases relative to a preset calibration setting, the same geometric distance at each calibration setting is represented by an increasing number of pixels. For example, a line that is 10 pixels long at the preset calibration setting (z₁ relative to z₅) may be 5 feet of geometric distance on the calibration plane, but 5 feet at a second calibration setting (z₂ relative to z₅) appears as a 15-pixel line. Inversely, 10 pixels at a preset calibration setting may be 5 feet of geometric distance between points at a similar height, but 10 pixels at an additional calibration setting above the preset calibration setting represents smaller geometric distances between points at that height. Using the illustration of FIG. 6C, a calibration adjustment for an additional calibration setting may be expressed for distance-to-pixel adjustments as follows (using the height at z₂ as an example):

$${x}_{2} = \frac{{x}_{1} ( {z}_{5} - {z}_{2} )}{( {z}_{5} - {z}_{1} )}$$

The terms z₅−z₂ and z₅−z₁ indicate elevation changes between calibration settings, x₂ is the distance-to-pixel calibration, and x₁ is the distance-to-pixel calibration setting at height z₁ (as depicted in FIG. 6B this is also the preset calibration setting). FIG. 6C annotates the top-down image of FIG. 6A with the distance-to-pixel calibration adjustment factors for each respective fiducial, according to some implementations. Camera intrinsics, and correction for focal length or distortions may further modify the calibration adjustment for a given calibration setting.

With reference to FIGS. 6A-6C, it will be appreciated that orthographic images captured at the orthographic position z₅ provide advantageously high accuracy for determining real-world distance values for objects at the preset calibration setting (height z₁) since, e.g., camera intrinsics are well-accounted for in the calibration. Nevertheless, the calibration adjustments discussed herein allow useful calculations of real-world distance values for features at multiple known heights.

In some implementations, all of the calibration settings along the flight path of the drone may be at heights other than the preset calibration height z₁. In such implementations, a calibration adjustment may be made for each calibration setting height to which the drone may move.

In some other implementations, calibration adjustments may be avoided for some or all of the various heights (e.g., z₂, z₃, and z₄) having a fiducial and related structural feature of interest. For example, a drone may have an imaging system that has multiple preset calibration settings, some of which may coincide with some or all of the heights of the fiducials. For example, the imaging system may include a camera with multiple preset calibration settings, at least some of which may correspond to the heights of individual ones of the fiducials (e.g., first and second preset calibration settings may correspond to first and second heights of first and second fiducials, respectively). As another example, the drone may include multiple cameras each having a different preset calibration setting. As a result, calibration adjustments are not needed for heights of fiducials that coincide with these preset calibration settings. Rather, one or more images may simply be captured from an orthographic position at the preset calibration setting height, and distance values for features in those images may be determined using the preset calibration settings for features that are present on the calibration planes associated with these calibration settings. Calibration adjustments may be used to calculate values for features at other heights, as discussed herein.

In some implementations, rather than making calibration adjustments, for some or all of the different calibration setting heights z₁, z₂, z₃, and z₄, the drone may be configured to move vertically to a preset calibration setting height corresponding to the heights z₁, z₂, z₃, and z₄. That is, the preset calibration setting height may be understood to be a predefined calibration distance from a particular calibration plane, with the preset calibration setting height being the height of the orthographic position from which an orthographic image is captured. In some implementations, the drone may be configured to ascend to the predefined calibration distance for each of multiple ones of the heights z₁, z₂, z₃, and z₄. For example, where the predefined calibration distance is D_{pc}, the drone may ascend to a first height equal to z₁+D_{pc} to capture a first image of a structure at the first height for calculating distance values for features at height z₁; the drone may then ascend to a second height equal to z₂+D_{pc} to capture a second image of the structure at that second height for calculating distance values for features at height z₂; the drone may then ascend to a third height equal to z₃+D_{pc} to capture a third image of the structure at that third height for calculating distance values for features at height z₃; etc. As a result, the preset calibration setting may be used and calibration adjustments may be avoided for heights for which an image is captured of a structure using an imager at a height of the predefined calibration distance above the corresponding one of the heights z₁, z₂, z₃, and z₄.

With reference now to FIGS. 7-14B, as discussed above, in some implementations, semantic labels may be generated as disclosed in US 2021/0243362, the entirety of which is incorporated by reference herein. FIG. 7 illustrates a frame 3600 with portions of house 3602 outside the display borders. A segmentation mask may be applied to identify pixels associated with house 3602, or bounding box 3601 to envelop such segmentation mask or house 3602 otherwise, would abut the left boundary of frame 3600. This is single channel segmentation bounding, single channel meaning applying to a single classification target like house 3602 in FIG. 7. Such bounding box generation could facilitate identification and framing of a fiducial incident to calibration setting operations. For example, identifying a particular feature and properly framing the fiducial within a drone imager frame could improve the likelihood the drone is at a particular position when it observed the fiducial.

Subcomponents or subfeatures of a subject may could convey additional information and lead to more specific identification, framing and positioning of an imager relative to fiducials for determining additional calibration settings for an imager as described above. Subcomponents and subfeatures, however, are not discretely identified by a single channel segmentation tool. Identifying such subcomponents and geometric subfeatures, provides more granular information for the subject, such as bounding box 3603 around the gable of house 3602 in FIG. 7. Active guidance as described throughout US 2021/0243362 may then be applied to this bounding box as necessary for proper framing of the sub-structure or fiducials.

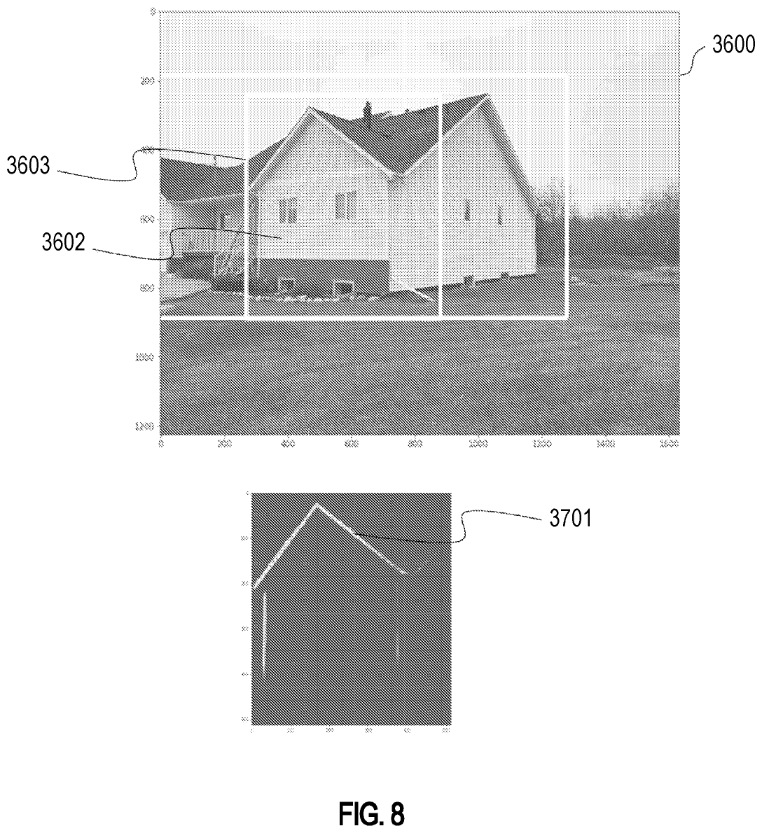

This sub-structure bounding box represents a multichannel mask cascade operation. Shown in FIG. 8 is segmentation mask 3701 corresponding to features attributable to a gable of house 3602. A bounding box to that encompasses mask 3701 may in turn produce bounding box 3603. Segmentation mask 3701 is one of a plurality of segmentation channels that may be produced from the input RGB image as seen in image frame 3600. A first channel may be segmentation for structure 3801 overall, another channel for the gable as in 3701. Some embodiments identify additional channels defining additional features, subcomponents or subfeatures, including fiducials for calibration settings, as described herein.

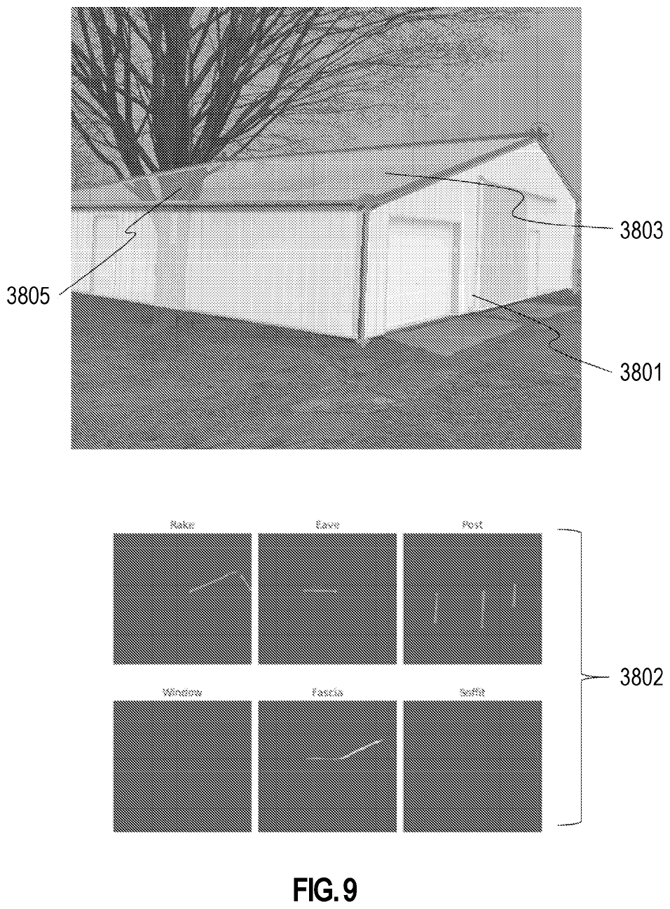

FIG. 9 depicts structure 3801 and a plurality of channels 3802 for sub-elements of structure 3801. In some implementations, a channel represents a classification output indicative of a pixel value for a specific attribute in an image; a segmentation mask for a particular feature may be a type of channel. Among channels 3802 are segmentation masks for rakes (e.g., lines culminating in apexes on roofs), eaves (e.g., lines running along roof edges distal to the roof's ridge), posts (e.g., vertical lines of facades such as at structure corners), fascia (e.g. structural elements following eaves), and soffit (e.g., the surface of a fascia that faces the ground). Many more sub-elements and therefore channels are possible, such as ridge lines, apex points, and surfaces are part of a non-exhaustive list.

In some embodiments, the output as shown in any one channel of channels 3802 may be used for fiducial identification or calibration settings as described above. In some embodiments, channel outputs are aggregated. For example, knowing that a sub-structure, such as a gable, is a geometric or structural representation of subfeatures, such as rakes and posts, a new channel may be built that is a summation of the output of the rake channel and the post channel, resulting in a representation similar to mask 3701 of FIG. 8. Similarly, if there is not already a roof channel from an associated activation map, knowing that roofs are a geometric or structural representation of rakes, eaves, and ridges, those channels may be aggregated to form a roof channel. In some implementations, a cascade of channel creation or selection may be established. While a single channel for a structure on the whole may be a preferred channel, a second channel category may be for sub-structures such as a gable or roof, and a third channel category may be for the foundational elements of sub-structures such as subfeatures like rakes, eaves, posts, fascia, soffits, windows, and so on.

In some implementations, a channel can be an activation map for data in an image frame (pre- or post-capture) indicating a model's prediction that a pixel in the image frame is attributable to a particular classification within a broader segmentation mask. The activation maps can be, then, an inverse representation, or single slice, of a segmentation mask trained for multiple classifications. By selectively isolating or combining single activation maps, new semantic information, masks, and bounding boxes can be created for sub-structures or subfeatures in the scene within the image frame and guidance prompts provided to optimize framing for those elements (e.g., the sub-structures or the subfeatures).

In some implementations, a neural network model comprises a plurality of layers for classifying pixels as subfeatures within an image. A final convolution layer separates out, into desired channels or subchannels, outputs representing only a single classification of the model's constituent elements. This allows feature representations across the image to influence prediction of subfeatures, while still maintaining a layer optimized for a specific feature. In other words, a joint prediction of multiple classes is enabled by this system (e.g., by computing platform 102 and its components). While the presence of points and lines within an image can be detected, shared feature representations across the network's layers can lend to more specific predictions; for example, two apex points connected by lines can predict or infer a rake more directly with the spatial context of the constituent features. In some implementations, each subchannel in the final layer output is compared during training to a ground truth image of those same classified features and any error in each subchannel is propagated back through the network. This results in a trained model that outputs N channels of segmentation masks corresponding to target subfeatures of the aggregate mask. Merely for illustrative purposes, the six masks depicted among group 3802 reflect a six-feature output of such a trained model. Each activation map in these channels is a component of an overall segmentation mask (or as aggregated a segmentation map of constituent segmentation masks).

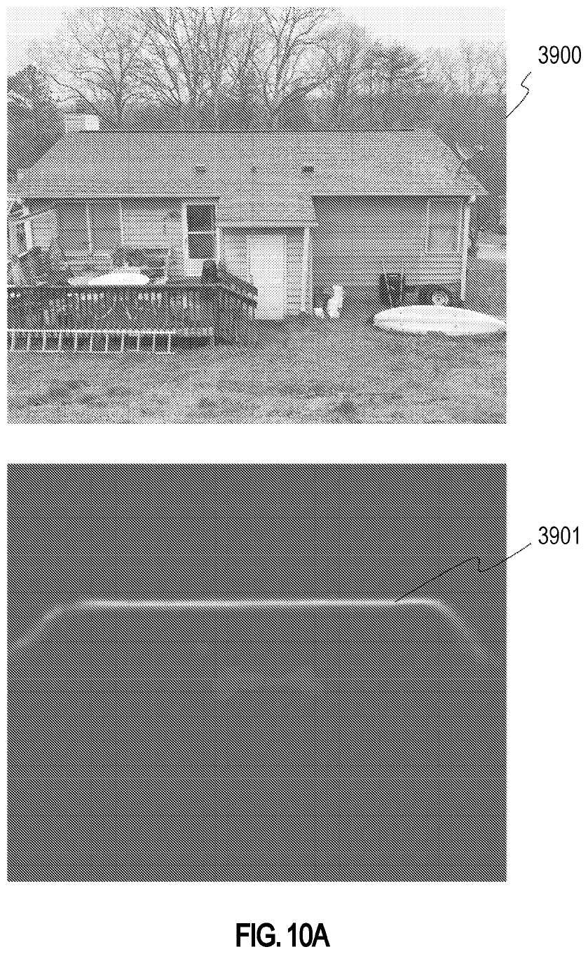

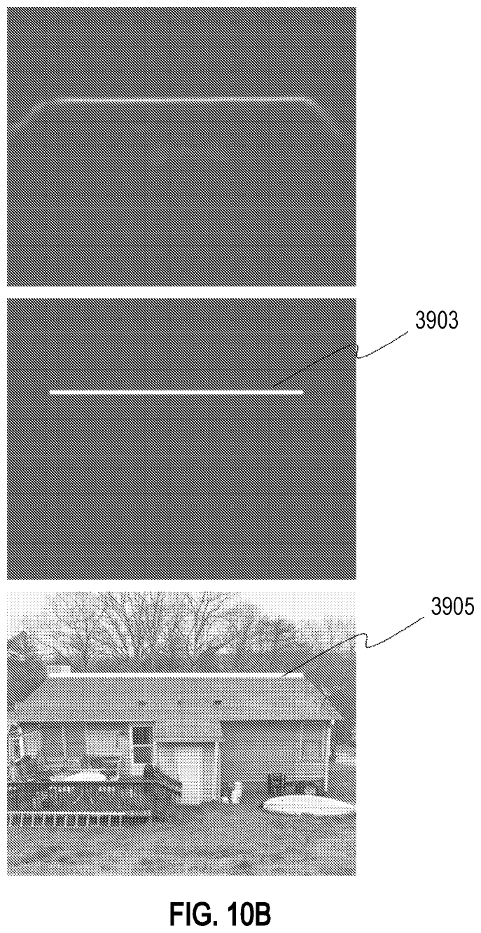

In some implementations, an intra-image parameter evaluation system can further refine an activation map output using filtering techniques. Keypoint detection techniques, such as the Harris corner algorithm, line detection techniques, such as Hough transforms, or surface detection techniques, such as concave hull techniques can clean noisy output. Referring to FIG. 10A, activation map 3901 can be one of a plurality of activation maps for image 3900, in this case a ridge line for a roof. As activation map 3901 corresponds to a linear feature, a linear detection technique may be applied to the pixels of 3901, resulting in smoothed linear feature 3903 of FIG. 10B. This linear feature may then be overlaid on image 3900 to depict a clean semantic labeling 3905. As discussed above, these may be grouped with other such activation map outputs or refined representations and applied to a scene. Grouping logic is configurable for desired sub-structures or subfeatures. For example, a rake activation map combined with a post activation map can produce a gable channel, despite no specific activation map for that type of sub-structure. Referring back to FIG. 9, such configurable channels can create clean overlays indicative of a classification but not prone to noisy pixel prediction or occlusions. Roof overlay 3803 may be created from a refined planar surface activation mask, or by filling in areas bounded by apex points, rakes, eave, and ridge line activation masks. Occluding tree 3805 does not create neighbor masks for the same planar element with such a cumulative channel derived from several activation mask outputs.

A drone piloting about a house to collect images or calibration data points can isolate subfeatures within an image frame associated with a particular category house feature, and guide imager positioning for that specific (sub) feature based on that (sub) feature's activation map channel.

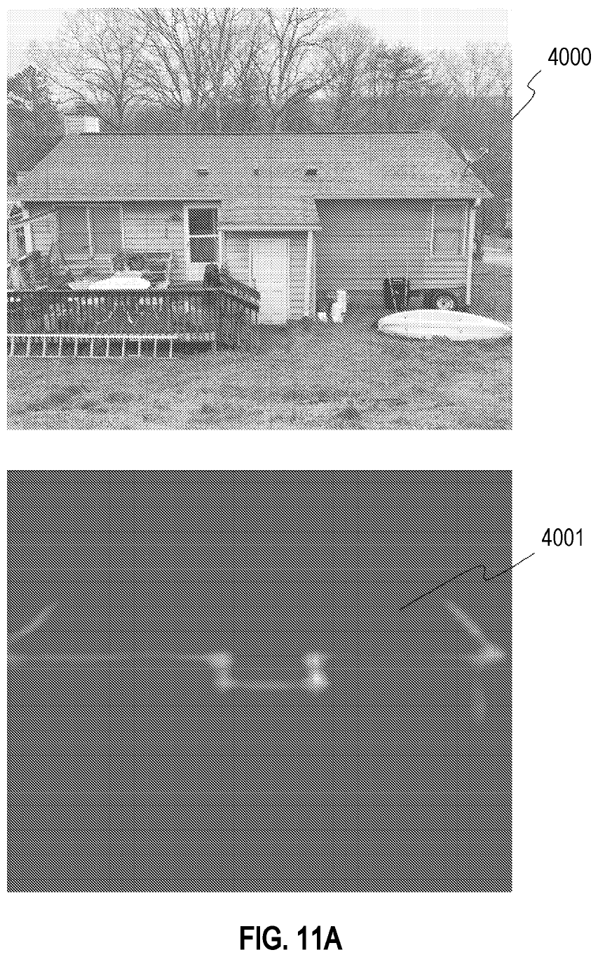

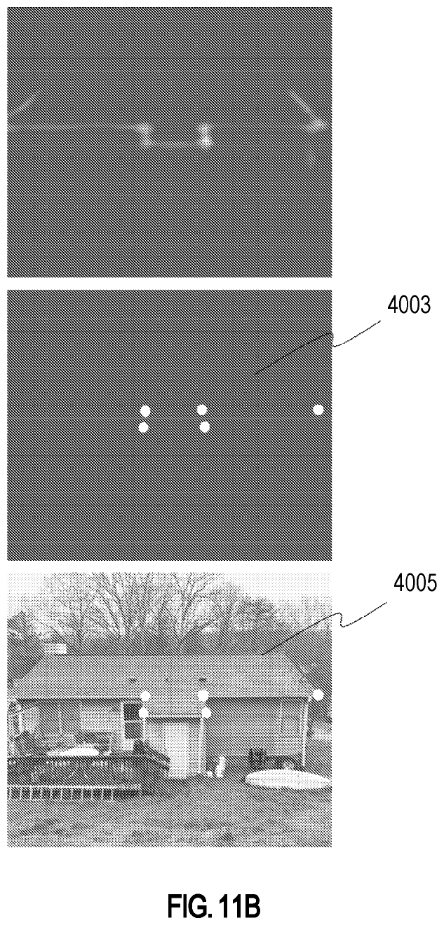

As another illustrative example, FIG. 11A depicts the same input image 3900 but with activation map 4001 for the fascia of the house. While linear detection techniques operated upon activation map 4001 would produce clean lines to the noisy data depicted in 4001, other techniques such as keypoint detection by Harris corner detection can reveal fascia endpoint channel 4003 that show semantic point labeling 4005 in FIG. 11B. These channels can be applied in building block like fashion to provide clean labeling to an image that overlays a structure, even over occlusions as described above with FIG. 9 and mitigating the presence of occluding tree 3805.

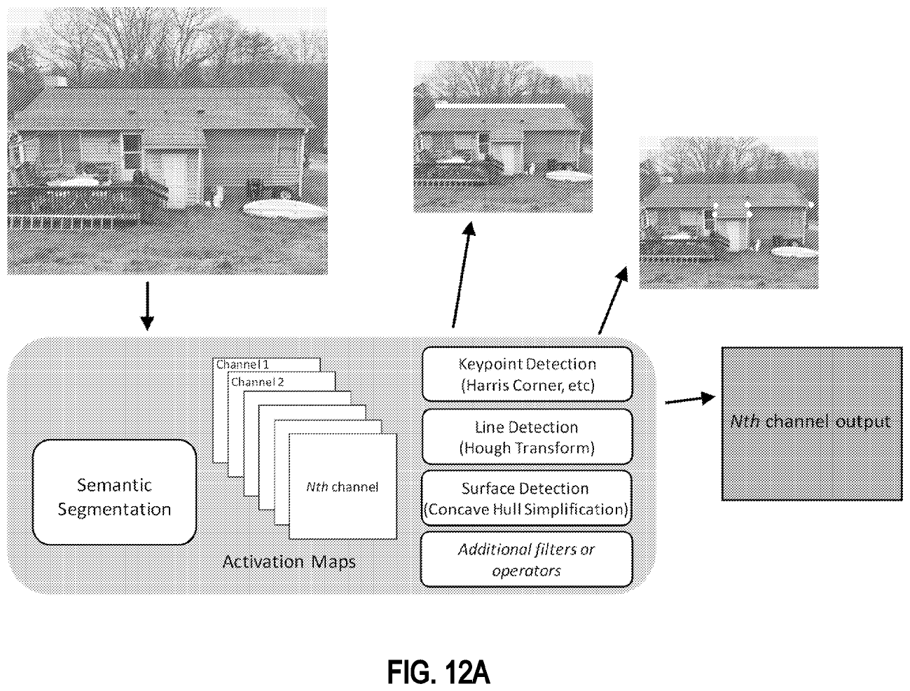

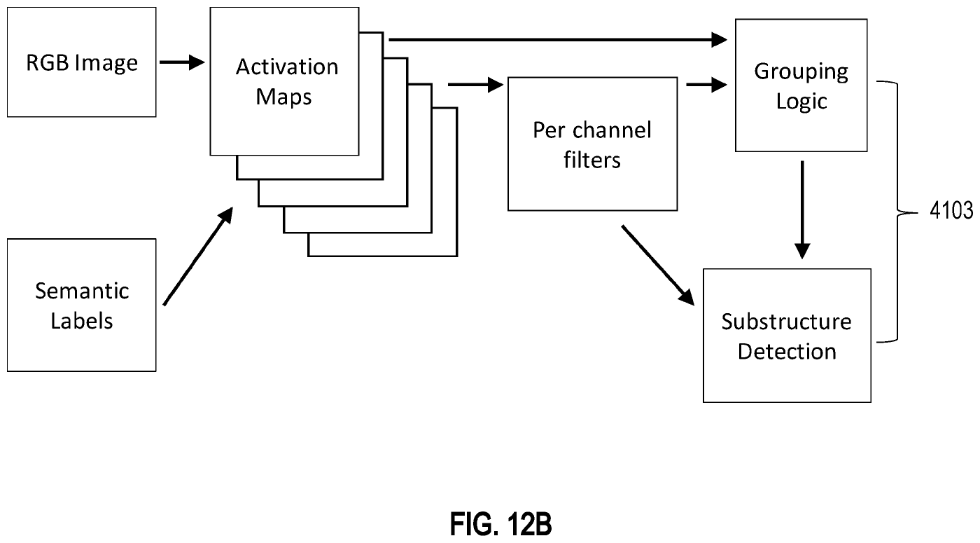

FIG. 12A illustrates this semantic scene understanding output as channels, wherein an input image is segmented for a plurality of N classification channels, and each classification extracted by a respective activation map. The activation map output may be further refined according to computer vision techniques applied as channel operators like keypoint detection, line detection or similar functions, though this step is not required. In some embodiments, a channel operator can aggregate multiple channels. These grouped or aggregates channel outputs create higher order substructure or subfeature channels based on the lower order activation map or channels for the input subject. In some implementations, bounding boxes can be fit to the resultant segmentation mask of lower order constituent channels or higher order aggregate channels as in steps 4103 of FIG. 12B. In some implementations, intermediate bounding boxes may be placed within the image and semantic segmentation performed within the intermediate box performed to identify discrete features such as soffit, fascia, trim and windows.

In some implementations, grouping of features or subfeatures may be configurable or automated. Users may select broad categories for groups (such as gable or roof) or configure unique groups based on use case. As the activation maps represent low order components, configuration of unique groups comprising basic elements, even structurally unrelated elements, can enable more responsive use cases. Automated grouping logic may be done with additional machine learning techniques. Given a set of predicted geometric constraints, such as lines or points generally or classified lines or points (e.g., as output by an activation map), a trained structure RCNN (Region-based Convolutional Neural Network) model can output grouped structures (e.g., primitives) or substructures.

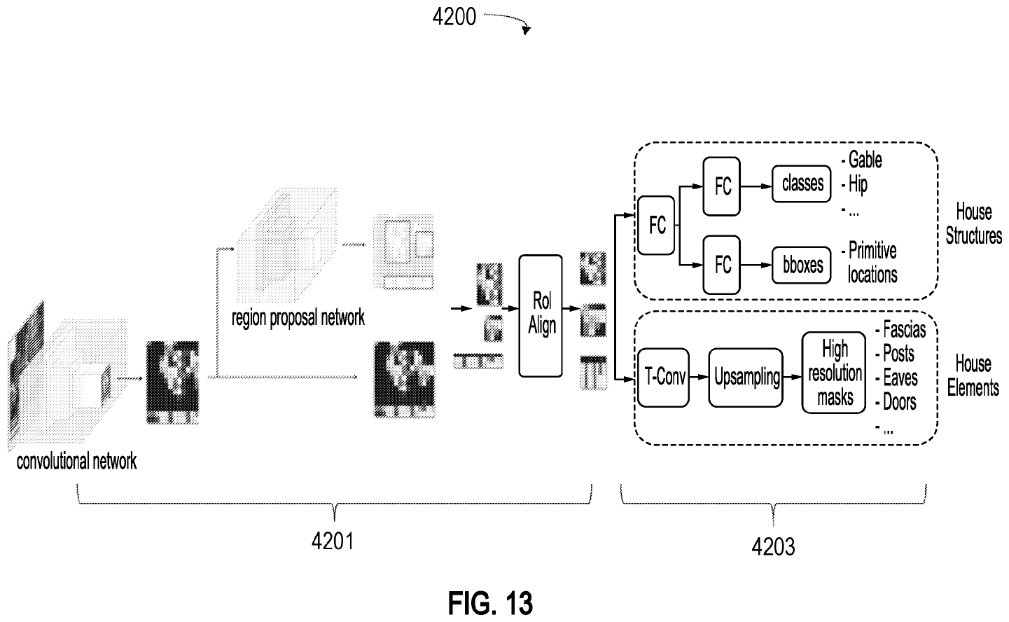

FIG. 13 illustrates an example of a structure RCNN architecture 4200. Similar in architecture to mask RCNN in the art using early networks heads 4201 for region proposal and alignment to a region of interest, the structure RCNN of FIG. 13 can add additional elements 4203 for more specific capabilities, such as grouping. Whereas traditional mask RCNN may detect individual elements separately, such as sub-components or features and subfeatures of a house, the structure RCNN first detects an overall target, such as House Structures (primitives like gables and hips) and then predicts masks for sub-components, such as House Elements (fascias, posts, eaves, rakes, etc.).

Whereas the House Elements head of network 4200 may use a combination of transpose convolution layer and upsampling layer, the House Structures head uses a series of fully connected layers to identify structural groupings within an image. This output may be augmented with the House Elements data, or the activation map data from the previously discussed network, to produce classified data within a distinct group. In other words, the structure RCNN architecture 4200 can discern multiple subcomponents or sub-structures within a single parent structure to avoid additional steps to group these subcomponents after detection into an overall target.

This avoids fitting a bounding box for all primitives or sub-structures and distinguishes to which sub-structure any one subfeature may be grouped. Again, using the gable detection illustrative use case, structure RCNN can identify a cluster of features first and then assign them as grouped posts to appropriate rakes to identify distinct sub-structures comprising those features, as opposed to predicting all rakes and posts in an image indicate “gable pixels.”

Segmentation masks based purely on aggregate activation maps may produce masks and bounding boxes encompassing multiple sub-structures within the image frame; while a gable may be expressed by posts and rakes, it is particular posts and rakes within an image that define any one gable. Without the parsing of sub-structures into respective groups as with the illustrated structure RCNN, active guidance to facilitate framing a particular sub-structure may be as difficult as guidance to capture the entire subject house, as the prompts may attempt to fit all particular pixels for a class of sub-structure rather than simply a single instance.

### OTHER IMPLEMENTATIONS

All of the processes described herein may be embodied in, and fully automated, via software code modules executed by a computing system that includes one or more computers or processors. The code modules may be stored in any type of non-transitory computer-readable medium or other computer storage device. Consequently, various electronic storage media discussed herein may be understood to be types of non-transitory computer readable media in some implementations. Some or all the methods may be embodied in specialized computer hardware.

Many other variations than those described herein will be apparent from this disclosure. For example, depending on the implementation, certain acts, events, or functions of any of the algorithms described herein can be performed in a different sequence or can be added, merged, or left out altogether (for example, not all described acts or events are necessary for the practice of the algorithms). Moreover, in certain implementations, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the implementations disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another implementation, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain implementations require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the implementations described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described implementations, the elements of which are to be understood as being among other acceptable examples. All such modifications and variations are intended to be included herein within the scope of this disclosure.

What is claimed is:

1. A method for measuring an angle of a roof facet, the method comprising:
initiating a flight path for an image capture device, the flight path including a launch phase and a measurement phase, wherein the launch phase initiates from a starting position and ends at a calibration position and the measurement phase initiates from the calibration position and ends at an orthographic position above an object comprising the roof facet;
detecting a first fiducial concurrent with the flight path towards the calibration position;
detecting a second fiducial concurrent with the flight path towards the orthographic position;
measuring an elevation change of the image capture device between the first fiducial and second fiducial;
capturing an orthographic image of the roof facet from the orthographic position;
generating an outline of the roof facet from the orthographic image; and
calculating a pitch of the roof from the outline of the roof facet and the elevation change.

2. The method of claim 1, wherein the image capture device is coupled to a drone.

3. The method of claim 1, wherein the first fiducial is detected by an object recognition machine learning network.

4. The method of claim 3, wherein the first fiducial detected by the object recognition machine learning network is a gutter coupled to the roof facet.

5. The method of claim 3, wherein the first fiducial detected by the object recognition machine learning network is an eave to the roof facet.

6. The method of claim 3, wherein the first fiducial detected by the object recognition machine learning network is a fascia line to the roof facet.

7. The method of claim 1, wherein the first fiducial is detected by line detection of a horizontal line.

8. The method of claim 1, wherein the first fiducial is detected by user input confirming the presence of the first fiducial at the elevation of the image capture device detection of a horizontal line.

9. The method of claim 1, wherein detecting the first fiducial establishes the calibration position of the flight path.

10. The method of claim 1, wherein the orthographic position is at a fixed height above the calibration position.

11. The method of claim 10, wherein the fixed height is 200 feet.

12. The method of claim 1, wherein the second fiducial is detected by an object recognition machine learning network.

13. The method of claim 12, wherein the second fiducial detected by the object recognition machine learning network is a roof apex.

14. The method of claim 12, wherein the second fiducial detected by the object recognition machine learning network is a ridge line.

15. The method of claim 1, wherein the second fiducial is a change of color intensity.

16. The method of claim 1, wherein an optical axis of the image capture device is substantially parallel to the ground concurrent with the flight path prior to the calibration position.

17. The method of claim 1, wherein the optical axis of the image capture device is substantially parallel to the ground concurrent with the flight path prior to detecting the second fiducial.

18. The method of claim 1, wherein the optical axis of the image capture device is substantially orthogonal to the ground concurrent with the flight path prior to the orthographic position.

19. The method of claim 1, wherein the image capture device is calibrated for converting pixel dimensions of features associated with the calibration position into geometric measurements from the orthographic position.

20. A non-transient computer-readable storage medium having instructions embodied thereon, the instructions being executable by one or more processors to perform a method for measuring an angle of a roof facet, the method comprising:
initiating a flight path for an image capture device, the flight path including a launch phase and a measurement phase, wherein the launch phase initiates from a starting position and ends at a calibration position and the measurement phase initiates from the calibration positions and ends at an orthographic position above an object comprising the roof facet;
detecting a first fiducial concurrent with the flight path towards the calibration position;
detecting a second fiducial concurrent with the flight path towards the orthographic position;
measuring an elevation change of the image capture device between the first fiducial and second fiducial;
capturing an orthographic image of the roof facet from the orthographic position; generating an outline of the roof facet from the orthographic image; and
calculating a pitch of the roof from the outline of the roof facet and the elevation change.

21. The computer-readable storage medium of claim 20, wherein the image capture device is coupled to a drone.

22. The computer-readable storage medium of claim 20, wherein the first fiducial is detected by an object recognition machine learning network.

23. The computer-readable storage medium of claim 22, wherein the first fiducial detected by the object recognition machine learning network is a gutter coupled to the roof facet.

24. The computer-readable storage medium of claim 22, wherein the first fiducial detected by the object recognition machine learning network is an eave to the roof facet.

25. The computer-readable storage medium of claim 22, wherein the first fiducial detected by the object recognition machine learning network is a fascia line to the roof facet.

26. The computer-readable storage medium of claim 20, wherein the first fiducial is detected by line detection of a horizontal line.

27. The computer-readable storage medium of claim 20, wherein the first fiducial is detected by user input confirming the presence of the first fiducial at the elevation of the image capture device detection of a horizontal line.

28. The computer-readable storage medium of claim 20, wherein detecting the first fiducial establishes the calibration position of the flight path.

29. The computer-readable storage medium of claim 20, wherein the orthographic position is at a fixed height above the calibration position.

30. The computer-readable storage medium of claim 29, wherein the fixed height is 200 feet.

31. The computer-readable storage medium of claim 20, wherein the second fiducial is detected by an object recognition machine learning network.

32. The computer-readable storage medium of claim 31, wherein the second fiducial detected by the object recognition machine learning network is a roof apex.

33. The computer-readable storage medium of claim 31, wherein the second fiducial detected by the object recognition machine learning network is a ridge line.

34. The computer-readable storage medium of claim 20, wherein the second fiducial is a change of color intensity.

35. The computer-readable storage medium of claim 20, wherein an optical axis of the image capture device is substantially parallel to the ground concurrent with the flight path prior to the calibration position.

36. The computer-readable storage medium of claim 20, wherein the optical axis of the image capture device is substantially parallel to the ground concurrent with the flight path prior to detecting the second fiducial.

37. The computer-readable storage medium of claim 20, wherein the optical axis of the image capture device is substantially orthogonal to the ground prior concurrent with the flight path prior to the orthographic position.

38. The computer-readable storage medium of claim 20, wherein the image capture device is calibrated for converting pixel dimensions of features associated with the calibration position into geometric measurements from the orthographic position.

39. A system configured for measuring an angle of a roof facet, the system comprising: one or more hardware processors configured by machine-readable instructions to:
initiate a flight path for an image capture device, the flight path including a launch phase and a measurement phase, wherein the launch phase initiates from a starting position and ends at a calibration position and the measurement phase initiates from the calibration positions and ends at an orthographic position above an object comprising the roof facet;
detect a first fiducial concurrent with the flight path towards the calibration position;
detect a second fiducial concurrent with the flight path towards the orthographic position;
measure an elevation change of the image capture device between the first fiducial and second fiducial;
capture an orthographic image of the roof facet from the orthographic position; generate an outline of the roof facet from the orthographic image; and
calculate a pitch of the roof from the outline of the roof facet and the elevation change.

40. The system of claim 39, wherein the image capture device is coupled to a drone.

41. The system of claim 39, wherein the first fiducial is detected by an object recognition machine learning network.

42. The system of claim 41, wherein the first fiducial detected by the object recognition machine learning network is a gutter coupled to the roof facet.

43. The system of claim 41, wherein the first fiducial detected by the object recognition machine learning network is an eave to the roof facet.

44. The system of claim 41, wherein the first fiducial detected by the object recognition machine learning network is a fascia line to the roof facet.

45. The system of claim 39, wherein the first fiducial is detected by line detection of a horizontal line.

46. The system of claim 39, wherein the first fiducial is detected by user input confirming the presence of the first fiducial at the elevation of the image capture device detection of a horizontal line.

47. The system of claim 39, wherein detecting the first fiducial establishes the calibration position of the flight path.

48. The system of claim 39, wherein the orthographic position is at a fixed height above the calibration position.

49. The system of claim 48, wherein the fixed height is 200 feet.

50. The system of claim 39, wherein the second fiducial is detected by an object recognition machine learning network.

51. The system of claim 50, wherein the second fiducial detected by the object recognition machine learning network is a roof apex.

52. The system of claim 50, wherein the second fiducial detected by the object recognition machine learning network is a ridge line.

53. The system of claim 39, wherein the second fiducial is a change of color intensity.

54. The system of claim 39, wherein an optical axis of the image capture device is substantially parallel to the ground concurrent with the flight path prior to the calibration position.

55. The system of claim 39, wherein the optical axis of the image capture device is substantially parallel to the ground concurrent with the flight path prior to detecting the second fiducial.

56. The system of claim 39, wherein the optical axis of the image capture device is substantially orthogonal to the ground prior concurrent with the flight path prior to the orthographic position.

57. The system of claim 39, wherein the image capture device is calibrated for converting pixel dimensions of features associated with the calibration position into geometric measurements from the orthographic position.

58. A method for measuring an angle of a roof facet, the method comprising:
initiating a flight path for an image capture device, the flight path including a calibration position and an orthographic position above an object comprising the roof facet;
detecting a first fiducial concurrent with the flight path towards the calibration position;
detecting a second fiducial concurrent with the flight path towards the orthographic position;
measuring an elevation change of the image capture device between the first fiducial and second fiducial;
capturing an orthographic image of the roof facet from the orthographic position;
generating an outline of the roof facet from the orthographic image; and
calculating a pitch of the roof from the outline of the roof facet and the elevation change.

59. The method of claim 58, wherein the image capture device is coupled to a drone.

60. The method of claim 58, wherein the first fiducial is detected by an object recognition machine learning network.

61. The method of claim 60, wherein the first fiducial detected by the object recognition machine learning network is a gutter coupled to the roof facet.

62. The method of claim 60, wherein the first fiducial detected by the object recognition machine learning network is an eave to the roof facet.

63. The method of claim 60, wherein the first fiducial detected by the object recognition machine learning network is a fascia line to the roof facet.

64. The method of claim 58, wherein the first fiducial is detected by line detection of a horizontal line.

65. The method of claim 58, wherein the first fiducial is detected by user input confirming the presence of the first fiducial at the elevation of the image capture device detection of a horizontal line.

66. The method of claim 58, wherein detecting the first fiducial establishes the calibration position of the flight path.

67. The method of claim 58, wherein the orthographic position is at a fixed height above the calibration position.

68. The method of claim 67, wherein the fixed height is 200 feet.

69. The method of claim 58, wherein the second fiducial is detected by an object recognition machine learning network.

70. The method of claim 69, wherein the second fiducial detected by the object recognition machine learning network is a roof apex.

71. The method of claim 69, wherein the second fiducial detected by the object recognition machine learning network is a ridge line.

72. The method of claim 58, wherein the second fiducial is a change of color intensity.

73. The method of claim 58, wherein an optical axis of the image capture device is substantially parallel to the ground concurrent with the flight path prior to the calibration position.

74. The method of claim 58, wherein the optical axis of the image capture device is substantially parallel to the ground concurrent with the flight path prior to detecting the second fiducial.

75. The method of claim 58, wherein the optical axis of the image capture device is substantially orthogonal to the ground prior concurrent with the flight path prior to the orthographic position.

76. The method of claim 58, wherein the image capture device is calibrated for converting pixel dimensions of features associated with the calibration position into geometric measurements from the orthographic position.

77. A non-transient computer-readable storage medium having instructions embodied thereon, the instructions being executable by one or more processors to perform a method as described in any one of claims 58-76.

78. A system configured for measuring an angle of a roof facet, the system comprising:
one or more hardware processors configured by machine-readable instructions to perform the functions as described in any one of claims 58-76.

79. A method for measuring an angle of a roof facet, the method comprising:
providing a flight path for implementation by a drone which includes an image capture device, the flight path causing the drone to:
ascend to detect a first fiducial on a building,
ascend from the first fiducial to detect a second fiducial on the building, and
subsequently ascend to an orthographic position above the building and obtain an image at the orthographic position;
analyzing the image obtained by the drone, wherein analyzing comprises identifying a run associated with the angle of the roof facet as depicted in the image; and
calculating the angle based on the run and a rise identified based on an elevation distance between the first fiducial and the second fiducial.

80. The method of claim 79, wherein first fiducial is a gutter, eave, or roof fascia.

81. The method of claim 79, wherein the second fiducial is a roof apex or ridge line.

82. The method of claim 79, wherein the drone executes a machine learning model to detect the first fiducial and second fiducial.

83. The method of claim 79, wherein the run is identified based on calibration information which indicates a real-world measure associated with one or more pixels in the image.

84. The method of claim 83, wherein the real-world measure is based on a height of the drone while at the orthographic position.

85. A non-transient computer-readable storage medium having instructions embodied thereon, the instructions being executable by one or more processors to perform a method as described in any one of claims 79-84.

86. A system configured for measuring an angle of a roof facet, the system comprising:
one or more hardware processors configured by machine-readable instructions to perform the functions as described in any one of claims 79-84.

87. A method for measuring an angle of a roof facet of a building, the method implemented by a system comprising an unmanned aerial vehicle (UAV) comprising one or more processors, and the method comprising:
detecting a first fiducial at a first height of the building, wherein the UAV ascends at least to the first height;
detecting a second fiducial at a second height of the building, wherein the UAV ascends at least to the second height;
capturing, by the UAV, an orthographic image of the roof facet from an orthographic position at a third height above the second height,
wherein the first height, second height, and orthographic image are usable to determine the angle of the roof facet.

88. The method of claim 87, wherein detecting the first fiducial and second fiducial is based on an image capture device included in the UAV.

89. The method of claim 87, wherein the first fiducial is a gutter, eave, or roof fascia.

90. The method of claim 87, wherein the second fiducial is a roof apex or ridge line.

91. The method of claim 87, wherein the third height is 200 feet.

92. A non-transient computer-readable storage medium having instructions embodied thereon, the instructions being executable by one or more processors to perform a method as described in any one of claims 87-91.

93. A system configured for measuring an angle of a roof facet, the system comprising an unmanned aerial vehicle and one or more hardware processors configured by machine-readable instructions to perform the functions as described in any one of claims 87-91.

94. A non-transient computer-readable storage medium having instructions embodied thereon, the instructions being executable by one or more processors to perform a method for generating a plurality of calibration settings for an object in a single image, the method comprising:
initiating an image capture device motion path about the object, the motion path comprising a plurality of detected calibration points and concluding at a final position;
detecting a first fiducial concurrent with the motion path towards the final position;
detecting a second fiducial concurrent with the motion path towards the final position;
measuring a first elevation change of the image capture device between the first fiducial and the final position;
measuring a second elevation change of the image capture device between the second fiducial and the final position;
capturing an image of the object from the final position;
generating a first calibration plane for the image based on the first elevation change;
generating a second calibration plane for the image based on the second elevation change; and
calculating two measurements between points of the object, where the first measurement is between points that lie on the first calibration plane and the second measurement is between points that lie on the second calibration plane.
